(19) United States
(12) Patent Application Publication
(10) Pub. No.: US 2012/0141190 A1
(43) Pub. Date: Jun. 7, 2012

(54) Expansion Joint

(75) Inventor: Justin L. Bailey, League City, TX (US)

(73) Assignee: MODERN CEMENT, LLC, League City, TX (US)

(21) Appl. No.: 12/960,781

(22) Filed: Dec. 6, 2010

(51) Int. Cl. F16B 17/00

(52) U.S. Cl. 403/28

(57) ABSTRACT

An expansion joint having gaps is used for cracks in surfacing. In an embodiment, an expansion joint has an upper body having an upper body gap. The expansion joint also has a lower body having a lower body gap. In addition, the expansion joint has a wedge. The wedge is disposed between the upper body and the lower body.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to the field of expansion joints and more specifically to the field of expansion joints having upper and lower bodies with gaps and also with wedges disposed between the bodies.

2. Background of the Invention

With urban and rural development, there is an increased amount of surfacing such as pavement. Cracks that occur in the pavement are a common problem. The cracks may occur by any of a number of different reasons such as expansion, contraction, use, and the like.

Different methods have been developed to overcome the pavement cracks. One developed method is the use of pavement gaps. Drawbacks to the use of pavement gaps include that the pavement gaps are openings in the pavement. Methods have been developed to overcome such drawbacks. One developed method is the use of expansion joints. Conventional expansion joints are typically made of wood or soft caulking and are placed in the pavement gaps. Drawbacks to conventional expansion joints include inefficient fitting within the cracks. Additional drawbacks include degradation of the expansion joints due to weather exposure and water.

Consequently, there is a need for an improved expansion joint.

### BRIEF SUMMARY OF SOME OF THE PREFERRED EMBODIMENTS

These and other needs in the art are addressed in one embodiment by an expansion joint. The expansion joint has an upper body comprising an upper body gap. The expansion joint also has a lower body comprising a lower body gap. In addition, the expansion joint has a wedge. The wedge is disposed between the upper body and the lower body.

These and other needs in the art are addressed in another embodiment by an expansion joint. The expansion joint has an upper body comprising a gap, a grip, an upper base and a lower base. The upper base has a greater diameter than the lower base.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of an expansion joint having wedges between upper and lower bodies, a stabilizer region, and grips;

FIG. 2 illustrates another embodiment of an expansion joint having an upper body with a gap and lower body with a gap;

FIG. 3 illustrates an embodiment of an expansion joint having ports;

FIG. 4 illustrates an embodiment of an expansion joint having a stabilizer region between gaps;

FIG. 5 illustrates an embodiment of an expansion joint having a gap and grips;

FIG. 6 illustrates an embodiment of an expansion joint having a rounded lower base; and

FIG. 7 illustrates an embodiment of an expansion joint with a stabilizer region and a lateral stabilizer region.

### DETAILED DESCRIPTION OF THE PREFERRED EMBODIMENTS

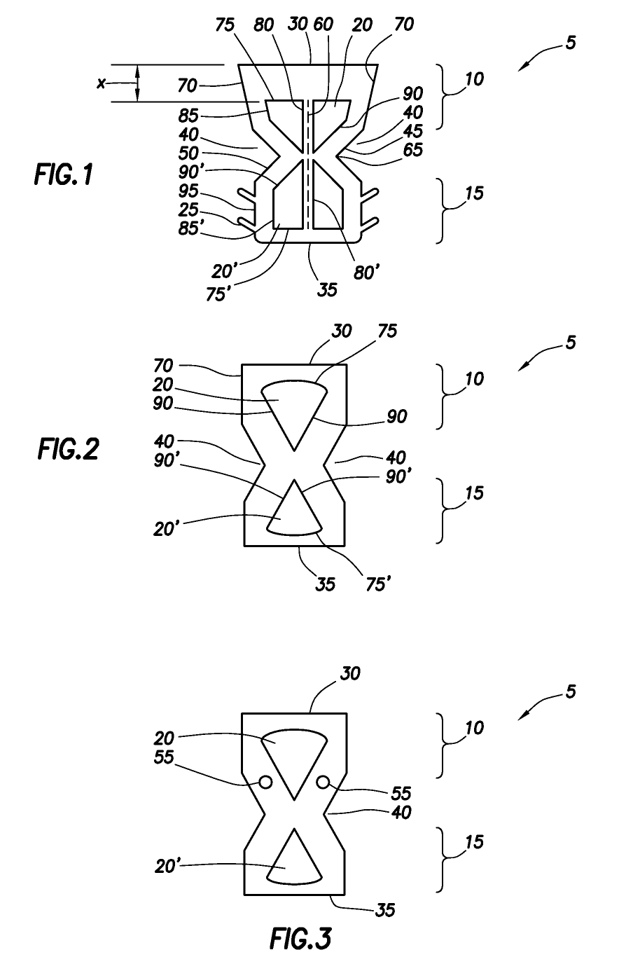

FIG. 1 illustrates an embodiment of an expansion joint 5 having upper body 10, lower body 15, grips 25, wedges 40, and stabilizer region 60. Expansion joint 5 may be composed of any material suitable for use in surfacing. For instance, examples of suitable materials include plastics, rubbers, and the like. In an embodiment, expansion joint 5 comprises polyvinyl chloride. Expansion joint 5 may have any desired measure of hardness. In an embodiment, expansion joint 5 may have a measure of hardness from about 50 durometers to about 125 durometers, alternatively from about 75 durometers to about 125 durometers, and alternatively from about 50 durometers to about 75 durometers. Expansion joint 5 may be used in cracks in any type of surfacing. In an embodiment, the surfacing is pavement. For instance, without limitation, examples of types of pavement include concrete and asphalt concrete. Therefore, expansion joint 5 may be used in pavements that may be used as road surfaces, parking lots, runways, sidewalks, floorings, and the like.

In an embodiment as shown in FIG. 1, wedges 40 are disposed between upper body 10 and lower body 15. Expansion joint 5 has a wedge 40 on opposing sides of expansion joint 5. Wedges 40 provide a region of expansion joint 5 having a smaller diameter than upper body 10 and lower body 15. Without limitation, wedges 40 facilitate flexibility of expansion joint 5 when expansion joint 5 is pushed into a crack in surfacing. Further, without limitation, wedges 40 reduce the material used in expansion joint 5 and thereby reduces cost and the weight of expansion joint 5. Each wedge 40 includes upper wedge surface 45 and lower wedge surface 50. Upper wedge surface 45 extends inward from upper body 10, and lower wedge surface 50 extends inward from lower body 15. Upper wedge surface 45 and lower wedge surface 50 intersect at wedge point 65. Each wedge 40 has a wedge point 65 on opposing sides from each other.

As shown in FIG. 1, upper body 10 has upper base 30 on the opposing end of upper body 10 from lower body 15. In embodiments, upper base 30 provides a surface by which pressure may be applied to expansion joint 5 to force expansion joint 5 into a crack in surfacing. For instance, without limitation, a hammer may be used to contact upper base 30 and provide sufficient force to expansion joint 5 to force expansion joint 5 into a crack. In an embodiment as illustrated, upper base 30 has a substantially flat surface. Further, in an embodiment as illustrated, upper base 30 is on a plane perpendicular to the plane of stabilizer region 60. In some embodiments, upper base 30 may be the only portion of expansion joint 5 exposed outside of the crack after expansion joint 5 is pushed into a crack. Upper body 10 also has upper body sides 70 on opposing sides of upper body 10. Upper body sides 70 extend from upper base 30 to upper wedge surface 45. In an embodiment as illustrated, upper body sides 70 extend inward (i.e., at an angle less than 90 degrees from upper base 30) from upper base 30 to upper wedge surface 45, thereby providing a reduced diameter of upper body 10 as upper body sides 70 extend downward. Without limitation, upper body sides 70 extending inward facilitates the forcing of expansion joint 5 into a crack. In alternative embodiments (not illustrated), upper body sides 70 have about a 90 degree angle with upper base 30. In embodiments as shown, each upper body side 70 has about the same angle with upper base 30 as the other upper body side 70. In embodiments as shown, upper body 10 has two gaps 20. In alterative embodiments (not illustrated), upper body 10 may have one gap 20 or more than two gaps 20. Gaps 20 provide voids through expansion joint 5. Without limitation, gaps 20 facilitate flexibility of expansion joint 5 when expansion joint 5 is pressed into a crack. Further, without limitation, gaps 20 reduce the material used in expansion joint 5 and thereby reduce cost and the weight of expansion joint 5. Gaps 20 may have any desired shape. In an embodiment as shown, gap 20 has a gap top side 75, gap interior side 80, gap outer side 85, and gap angled side 90. In embodiments as shown, gap top side 75 is substantially parallel to upper base 30. Gap interior side 80 is substantially parallel to the gap interior side 80 of the opposing gap 20 of upper body 10. In embodiments, gap interior side 80 is about perpendicular to gap top side 75. Gap outer side 85 is the side of gap 20 proximate to upper body side 70. Gap outer side 85 may have any desired angle to gap top side 75. In an embodiment, gap outer side 85 has about the same angle to gap top side 75 as upper body side 70 has to upper base 30. Gap angled side 90 extends inward from gap outer side 85 to gap interior side 80. Gap angled side 90 may have any desired angle to gap outer side 85. In an embodiment as shown, gap angled side 90 has about the same angle to gap outer side 85 as upper wedge surface 45 has to upper body side 70. Upper body 10 has a distance x between gap top side 75 and upper base 30. Distance x may be of any desired distance. In an embodiment, distance x is a distance sufficient to prevent damage to expansion joint 5 when vehicles cross over expansion joint 5 when expansion joint 5 is in a crack. Without limitation, it may also be desired to not have distance x too large as the added material may add to the cost and weight of expansion joint 5. In an embodiment, distance x is from about 0.1 inches to about 0.5 inches, alternatively from about 0.25 inches to about 0.5 inches, and alternatively about 0.25 inches. In an embodiment, expansion joint 5 has a sufficient distance between gap angled side 90 and upper wedge surface 45 and a sufficient distance between gap outer side 85 and upper body side 70 to prevent damage to expansion joint 5 while facilitating flexibility when pushed into a crack. In an embodiment, such distances are about the same. In some embodiments, such distances are between about 0.1 inches and about 0.2 inches, alternatively about 0.13 inches.

In the embodiment of FIG. 1, lower body 15 has grips 25. Lower body 15 is shown with two grips 25 on opposing sides of lower body 15. In alternative embodiments, lower body 15 may have one grip 25 on a side of lower body 15 or have more than two grips 25 on a side of lower body 15. Grips 25 extend outward from lower body 15. In an embodiment as illustrated, grips 25 extend in an upward direction (i.e., grips 25 extend outward from lower body side 95 at an angle less than 90 degrees to lower body side 95). Without limitation, grips 25 extend at an angle less than 90 degrees to lower body side 95 because if grips 25 extend at 90 degrees or more to lower body side 95 then grips 25 may be damaged or entangled when expansion joint 5 is forced into a crack. In embodiments, grips 25 provide upper body 10 and/or lower body 15 with a diameter greater than that of upper base 30 (i.e., grips 25 extend farther than diameter of upper base 30). In an embodiment, lower body sides 95 are substantially parallel to each other. In an embodiment as illustrated, lower body 15 has two gaps 20′. In alterative embodiments (not illustrated), lower body 15 may have one gap 20′ or more than two gaps 20′. Gaps 20′ of lower body 15 may have any desired shape. In an embodiment as shown, gap 20′ has a gap top side 75′, gap interior side 80′, gap outer side 85′, and gap angled side 90′. In embodiments as shown, gap top side 75′ is substantially parallel to lower base 35. Gap interior side 80′ is substantially parallel to the gap interior side 80′ of the opposing gap 20′ of lower body 15. In embodiments, gap interior side 80′ is about perpendicular to gap top side 75′. Gap outer side 85′ is the side of gap 20′ proximate to lower body side 95. Gap outer side 85′ may have any desired angle to gap top side 75′. In an embodiment, gap outer side 85′ has about the same angle to gap top side 75′ as lower body side 95 has to lower base 35. Gap angled side 90′ extends inward from gap outer side 85′ to gap interior side 80′. Gap angled side 90′ may have any desired angle to gap outer side 85′. In an embodiment as shown, gap angled side 90′ has about the same angle to gap outer side 85′ as lower wedge surface 50 has to lower body side 95.

It is to be understood that the embodiment of expansion joint 5 shown in FIG. 1 is not limited to only lower body 15 having grips 25. In alternative embodiments (not illustrated), upper body 10 and/or lower body 15 may have a grip 25 or grips 25.

In an embodiment as illustrated in FIG. 1, upper base 30 is wider than lower base 35. Without limitation, upper base 30 being wider than lower base 35 facilitates pushing of expansion joint 5 into the crack. In an embodiment, an expansion joint 5 with an upper base 30 having a diameter slightly wider than that of the crack but sufficient to allow expansion joint 5 to be forced into the crack with only upper base 30 exposed is selected. In an embodiment, lower body 15 has a diameter smaller than that of the crack.

In the embodiment of FIG. 1, expansion joint 5 also includes a stabilizer region 60. Stabilizer region 60 comprises the region of expansion joint 5 that extends between gaps 20, 20′ and from upper body 10 to lower body 15. It is to be understood that stabilizer region 60 is shown with a dashed line for illustrative purposes only. Without limitation, stabilizer region 60 provides stability to expansion joint 5 during expansion/contraction of the surfacing and during the placement of expansion joint 5 in the crack. In an embodiment as shown, stabilizer region 60 is longitudinally disposed in expansion joint 5.

FIG. 2 illustrates an embodiment of expansion joint 5 in which expansion joint 5 has one gap 20 in upper body 10 and one gap 20′ in lower body 15. In such an embodiment, expansion joint 5 has no grips 25. In alternative embodiments (not illustrated), expansion joint 5 has grips 25. In such an embodiment, gaps 20, 20′ have an alternative configuration having rounded gap top sides 75, 75′ and opposing gap angled sides 90, 90′. In an embodiment as shown, upper body sides 70 are parallel.

FIG. 3 illustrates an embodiment of expansion joint 5 of FIG. 2 having ports 55. Ports 55 allow liquids (i.e., water) to pass through expansion joint 5. Expansion joint 5 may have any suitable number of ports 55. Without limitation, ports 55 minimize liquids from undermining the surfacing and damaging the surfacing. Ports 55 are shown disposed in upper body 10 but in alternative embodiments (not illustrated) may be disposed in any suitable location on expansion joint 5.

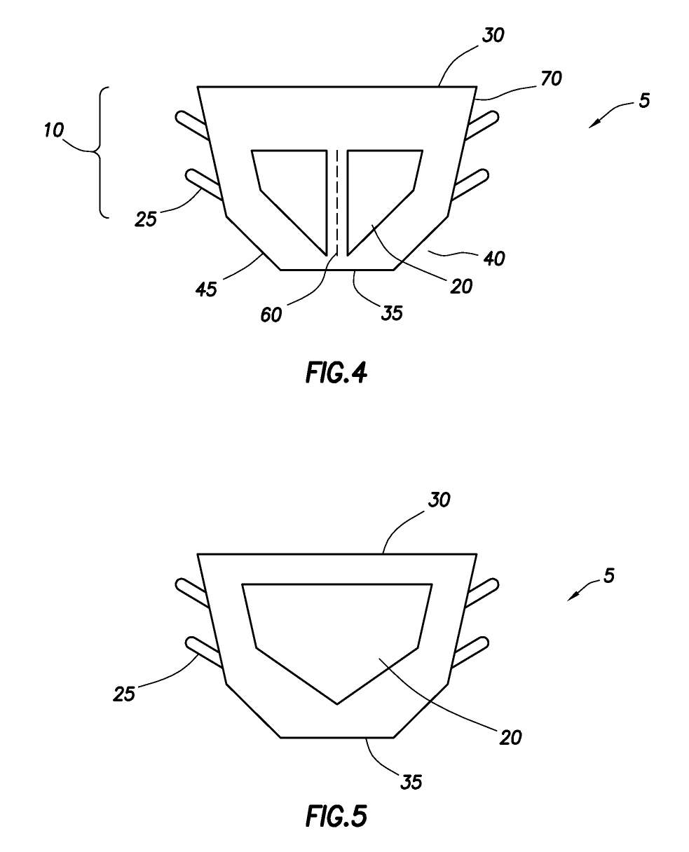

FIG. 4 illustrates an embodiment of expansion joint 5 in which expansion joint 5 does not have a lower body 15. In such an embodiment, wedge 40 only includes upper wedge surface 45. In alternative embodiments (not illustrated), expansion joint 5 does not have wedge 40 but has upper body side 70 extending to lower base 35. As shown, lower base 35 is on the opposing side of expansion joint 5 from upper base 30. FIG. 5 illustrates an embodiment of the expansion joint 5 of FIG. 4 in which expansion joint 5 has one gap 20.

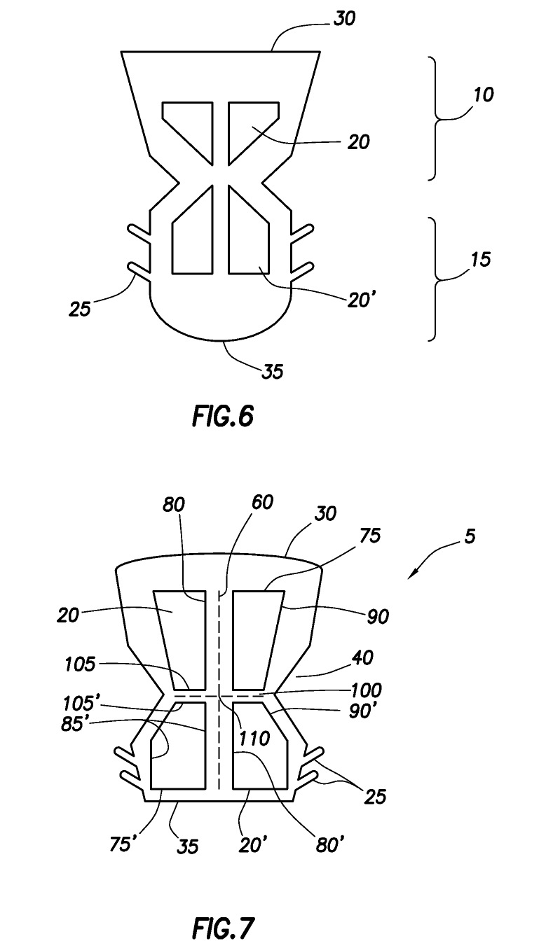

FIG. 6 illustrates an alternate embodiment of the expansion joint 5 shown in FIG. 1. In such an embodiment, lower base 35 is rounded. In an embodiment, lower base 35 has a convex curvature. Without limitation, the rounded lower base 35 facilitates expansion joint 5 pushing debris (i.e., dirt, etc.) when expansion joint 5 is forced into the crack.

FIG. 7 illustrates an embodiment of expansion joint 5 having lateral stabilizer region 100. Lateral stabilizer region 100 comprises the region of expansion joint 5 that extends laterally between gap bottom sides 105 and 105′. Gap bottom side 105 is on the opposing side of gap 20 from gap top side 75, and gap bottom side 105′ is on the opposing side of gap 20′ from gap top side 75′. In an embodiment as illustrated, lateral stabilizer region 100 extends across stabilizer region 60. In embodiments, lateral stabilizer region 100 is about perpendicular to stabilizer region 60. In an embodiment as illustrated, lateral stabilizer region 100 and stabilizer region 60 cross each other at about center point 110 of expansion joint 5. It is to be understood that lateral stabilizer region 100 is shown with a dashed line for illustrative purposes only. Without limitation, lateral stabilizer region 100 provides stability to expansion joint 5 during expansion/contraction of the surfacing and during the placement of expansion joint 5 in the crack. As further shown in FIG. 7, gap angled side 90 extends from gap top side 75 to gap bottom side 105. In addition, gap angled side 90′ extends from gap top side 75′ to gap outer side 85′. In an embodiment, upper base 30 has a convex curvature. Without limitation, the convex upper base 30 facilitates disposition of expansion joint 5 into a crack.

It is to be understood that expansion joint 5 improves aesthetics and safety for surfacing by filling in cracks. In addition, expansion joint 5 minimizes weed growth.

Although the present invention and its advantages have been described in detail, it should be understood that various changes, substitutions and alterations may be made herein without departing from the spirit and scope of the invention as defined by the appended claims.

What is claimed is:

1. An expansion joint, comprising:
an upper body comprising an upper body gap;
a lower body comprising a lower body gap; and
a wedge, wherein the wedge is disposed between the upper body and the lower body.

2. The expansion joint of claim 1, wherein the expansion joint comprises a measure of hardness from about 50 durometers to about 125 durometers.

3. The expansion joint of claim 1, wherein the expansion joint comprises a wedge on opposing sides.

4. The expansion joint of claim 1, wherein the upper body comprises an upper base on an opposing end of the upper body from the lower body.

5. The expansion joint of claim 4, wherein the upper base is substantially flat.

6. The expansion joint of claim 4, wherein the upper body comprises an upper body side that extends inward from the upper base to the wedge.

7. The expansion joint of claim 1, wherein the upper body gap comprises a gap top side, and wherein the upper body comprises an upper base, and further wherein the gap top side is substantially parallel to the upper base.

8. The expansion joint of claim 1, further comprising a stabilizer region.

9. The expansion joint of claim 8, wherein the stabilizer region extends from the upper body to the lower body.

10. The expansion joint of claim 1, wherein the lower body comprises a lower base on an opposing end of the lower body from the upper body.

11. The expansion joint of claim 10, wherein the lower base is substantially flat.

12. The expansion joint of claim 10, wherein the lower base comprises a convex curvature.

13. The expansion joint of claim 1, further comprising at least one grip on opposing sides of the expansion joint.

14. The expansion joint of claim 13, wherein the lower body comprises a lower body side, and wherein the at least one grip extends outward from the lower body side at an angle less than 90 degrees.

15. The expansion joint of claim 1, further comprising a lateral stabilizer region.

16. The expansion joint of claim 1, further comprising a port.

17. The expansion joint of claim 1, further comprising an upper base and a lower base, wherein the upper base has a larger diameter than the lower base.

18. The expansion joint of claim 1, further comprising more than one upper body gap and more than one lower body gap.

19. An expansion joint, comprising an upper body comprising a gap, a grip, an upper base and a lower base, wherein the upper base has a larger diameter than the lower base.

20. The expansion joint of claim 19, wherein the expansion joint comprises a stabilizer region.
